(19) United States
(12) Patent Application Publication
(10) Pub. No.: US 2009/0296693 A1
(43) Pub. Date: Dec. 3, 2009

(54) Session Initiation Protocol Telephone System, Data Transmission Method, Server Unit, and Telephone Terminal

(75) Inventor: Yoshimitsu Ebisawa, Koganei-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/473,106

(22) Filed: May 27, 2009

(30) Foreign Application Priority Data
May 28, 2008 (JP) 2008-139552

(51) Int. Cl. H04L 12/66

(52) U.S. Cl. 370/352; 379/93.01; 379/220.01

(57) ABSTRACT

According to an aspect of the present invention, there is provided a Session Initiation Protocol (SIP) telephone system comprises a server unit, telephone terminals and a module. The server is connected to Internet Protocol (IP) network. The telephone terminals transmit and receive SIP messages to and from the server unit via the IP network. The module applies SIP messages regarding event notification to data transmission to form interactive communication paths among the server unit and each of the telephone terminals.

### CROSS-REFERENCE TO RELATED APPLICATIONS

This application is based upon and claims the benefit of priority from Japanese Patent Application No. 2008-139552, filed May 28, 2008, the entire contents of which are incorporated herein by reference.

### BACKGROUND

1. Field

One embodiment of the present invention relates to a Session Initiation Protocol (SIP) telephone system achieving voice communication via an Internet Protocol (IP) network, and a data transmission method, a server unit and a telephone terminal for use in the system.

2. Description of the Related Art

In recent years, so-called Voice over IP (VoIP) making voice communication by using an IP network has become mainly used. Connecting a terminal (personal computer, personal digital assistant [PDA], etc.) having a VoIP function to a local area network (LAN) enables use as a telephone set. In this kind of a telephone system, since outgoing call and incoming call are controlled on the basis of IP addresses, telephone terminals may be easily moved.

This kind of system usually uses an SIP for achieving a function such as call connection and presence management. As generally known, SIP transmits and receives various messages among a server and terminals for providing various services. While, on the one hand, SIP is advantageous to expand services and the system because SIP is a general-purpose protocol, SIP is disadvantageous in a case of a need of immediacy because SIP is a protocol of a request-response type.

For instance, for outgoing a call, an “INVITE” message is transmitted at a time point when all dial numbers are input completely after off-hook or pressing a line key. That is, until all the telephone numbers are input, a resource of an SIP server is not acquired, and the terminal during dial input seems empty (IDLE) from the SIP server. Therefore, if it takes a long time to apply the dial input, the SIP server may receive an incoming call message from another terminal, the SIP server may fail in making an outgoing call or may fail in receiving an incoming call although a line is empty (IDLE).

A technique which issues an acquisition message (NOTIFY [BUSY] message) to a resource management server upon operating line acquisition (off-hook or line key pressing), the SIP server which has received the message immediately returns an acquisition reception (ACCEPT) message, then, enables acquisition of the line instantly is disclosed in Jpn. Pat. Appln. KOKAI Publication No. 2002-152224. However, this technique cannot cope with such a case described hereinafter. That is, in the existing technique, if communication is cut off by a calling partner, a terminal returns a “200 OK” message after receiving a “BYE” message from the SIP server, and the SIP server transmits a cut-off tone to a user. Since the terminal in such a status is seemed to be empty from the SIP server, if the terminal has not been hooked off, there is a case of receiving an incoming call message from another terminal, and then, the terminal may not receive any incoming call although the line is free.

To achieve an SIP system having a function to be referred to as a multi-appearance which has been known in an existing key telephone system, the following failure may occur. The multi-appearance includes a function of arranging the same line to a plurality of terminals, and to achieve this function in the SIP system, each terminal having the same line monitors the status of each line by a presence function generally. That is, each terminal declares the monitoring of the shared line through the “SUBSCRIBE” message and the server notifies a change in status of monitoring line at every change through the “NOTIFY” message.

However, in this method, the sever notifies the change in status by using the reception of the “INVITE” message as a trigger. Therefore, when a plurality of users intend to transmit data from different terminals through the same line, there is a case in which only a request of a user who has transmitted an “INVITE” message in first becomes effective, and a user who has transmitted another “INVITE” message later cannot make an outgoing call, although the user has dialed perfectly.

It is not preferable for the above mentioned method because in a case, in which the terminal has a plurality of lines, since it becomes necessary to transmit a “SUBCRIBE” message for each line, and since it becomes necessary to transmit a “NOTIFY” message for each terminal, network traffic increases exponentially.

Before the “INVITE” message is transmitted, notifying off-hook and pressing of a line button to the server through a unique message, and immediately notifying the acquisition of the line to other terminals by means of the server which has received this message is a possible approach. However, it is not preferable because if there are firewalls or network address translation (NAT) among the terminals and the server, it becomes necessary to change setting for making the unique message pass, and it becomes impossible to use an application layer gateway (ALG) function.

As described above, the SIP telephone system is hard to respond quickly upon transmission of outgoing calls and upon cutting off of lines in a case where a plurality of terminals concern about one another, and then, something should be done about it. If a unique message defines to cope with this problem, since complex work, such as a change in setting of a firewall, is needed, it is necessary to deal with the problem by using the messages defined by means of SIP. It is also necessary to achieve the multi-appearance by the use of the SIP messages without increasing traffic.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting an example of an SIP telephone system of the present invention;

FIG. 2 is an exemplary sequence view depicting a first embodiment of messages to be transmitted and received among SIP terminals and an exchange server 20;

FIG. 3 is an exemplary view depicting that a line resource is immediately acquired by notification using a “PUBLISH” message;

FIG. 4 is an exemplary view depicting that there is a case in which a transmission failure occurs by notification using an “INVITE” message;

FIG. 5 is an exemplary schematic view depicting formation of a data communication path between the exchange server 20 and an SIP terminal 11 in the sequence of FIG. 2;

FIG. 6 is an exemplary sequence view depicting a second embodiment of messages to be transmitted and received among the SIP terminals and the exchange server 20;

FIG. 7 is an exemplary schematic view depicting formation of a data communication path between the exchange server 20 and the SIP terminal 11 in the sequence of FIG. 6;

FIG. 8 is an exemplary sequence view depicting a third embodiment of messages to be transmitted and received between the SIP terminals and the exchange server 20;

FIG. 9 is an exemplary schematic view depicting formation of a data communication path between the exchange server 20 and the SIP terminal 11 in the sequence of FIG. 8;

FIG. 10 is an exemplary sequence view depicting a fourth embodiment of messages to be transmitted and received among the SIP terminals and the exchange server 20; and

FIG. 11 is an exemplary schematic view depicting formation of a data communication path between the exchange server 20 and the SIP terminal 11 in the sequence of FIG. 10.

### DETAILED DESCRIPTION

Various embodiments according to the invention will be described hereinafter with reference to the accompanying drawings. In general, according to one embodiment of the invention, there is provided a Session Initiation Protocol (SIP) telephone system comprises a server unit, telephone terminals and a module. The server is connected to Internet Protocol (IP) network. The telephone terminals transmit and receive SIP messages to and from the server unit via the IP network. The module applies SIP messages regarding event notification to data transmission to form interactive communication paths among the server unit and each of the telephone terminals.

By taking such measures, it makes it possible for a network environment which can use SIP messages to form data communication paths among telephone terminals and a server unit. That is, applying (or diverting) messages to be used for presence management, such as a “SUBSCRIBE” message, a “NOTIFY” message and a “PUBLISH” message to data communication without being held to their frameworks enables formation of dedicated data communication paths among the terminals and the server. Therefore, it becomes able to inform on-hook, off-hook, etc., to the server unit, and it becomes able to immediately display a change in s status of a line. It becomes able to reduce network traffic because it is not necessary to declare subscription thorough a “SUBSCRIBE” message for each line button.

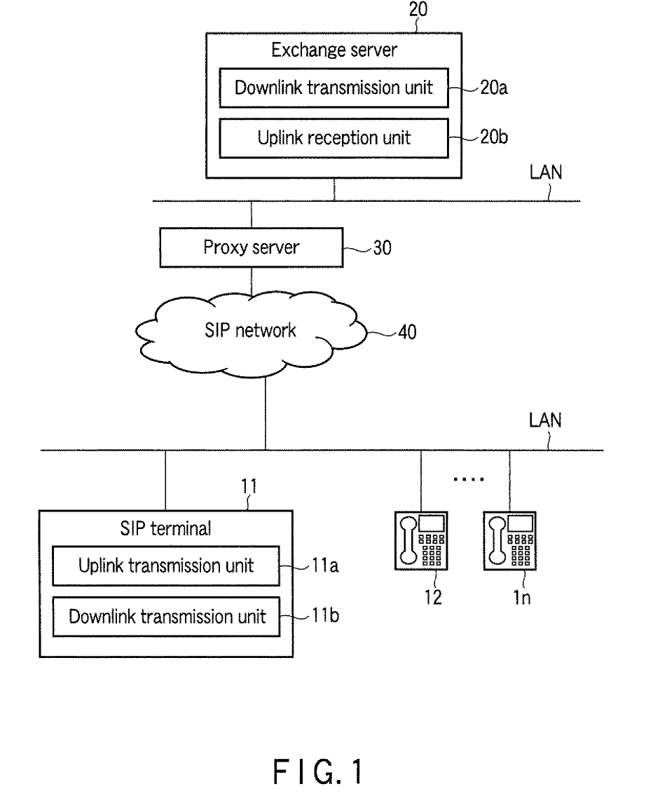

According to an embodiment, FIG. 1 shows a system view illustrating an embodiment of an SIP telephone system of the invention. In this system, a plurality of SIP terminals 11-1n are connected to an exchange server 20 via an SIP network 40. The SIP terminals 11-1n and the exchange server 20 mutually transmit and receive SIP messages via the SIP network 40. A proxy server 30 is disposed between the exchange server 20 and the SIP network 40, and then, the exchange server 20 is connected to a network positioned at the inner side of the SIP network 40 viewed from the proxy server 30.

The proxy server 30 is a so-called Application Layer Gateway (ALG), which substitutes for communication in and out of a network at a level of an application protocol such as Hypertext Transfer Protocol (HTTP) and File Transfer Protocol (FTP) in the Open System Interconnection (OSI) reference model seventh layer, and functions as a firewall against a LAN on an exchange server 20 side.

Meanwhile, the SIP terminal 11 (other SIP terminals 12-1n also work similarly) is provided with an uplink transmission module 11a and a downlink transmission module 11b as processing functions of the embodiment. The exchange server 20 includes a downlink transmission module 20a and an uplink reception module 20b. The modules perform processing functions to be achieved, for example, by software, and provide functions regarding transmission and receptions of various messages related to presence management and event notification. The details have been described in Request for Comments (RFC) 3265 of the Internet Engineering Task Force IEFT and the definition related thereto.

Plainly speaking, the functional modules 11a, 11b, 20a and 20b achieve functions of applying the SIP messages to be used for aiming to monitor objects to data transmission. That is, the modules 11a, 11b, 20a and 20b form data transmission paths among a server and terminals by using the messages such as “SUBSCRIBE”, “NOTIFY” and “PUBLISH” messages.

As well known, each of the SIP messages is a message in a text form, and sectioned into a header part and a body part on both sides of a space line. Description of data in the body part enables communication of data. The functional modules 11a, 11b, 20a and 20b each include a function of describing data and transmitting/receiving it, and a function of reading the described data. The data described in the body part is not limited to be described in the text form; the data may be described in a form in which a unique form, such as a binary form, is encoded in a text. The following will be described operations of each functional module of a first embodiment-a fourth embodiment in details.

### First Embodiment

In the first embodiment, the uplink transmission module 11a transmits the “SUBSCRIBE” message to the exchange server 20. When receiving the “SUBSCRIBE” message, after this, the transmission module 11a transmits data to the exchange server 20 by using the “PUBLISH” message. The downlink reception module 11b receives the data transmitted from the exchange server 20 using the “NOTIFY” message.

The uplink reception module 20b receives the “SUBCRIBE” message transmitted from the SIP terminal 11. After receiving the “SUBSCRIBE” message from the SIP terminal 11, the downlink transmission module 20a transmits the data to the SIP terminal 11 by using the “NOTIFY” message.

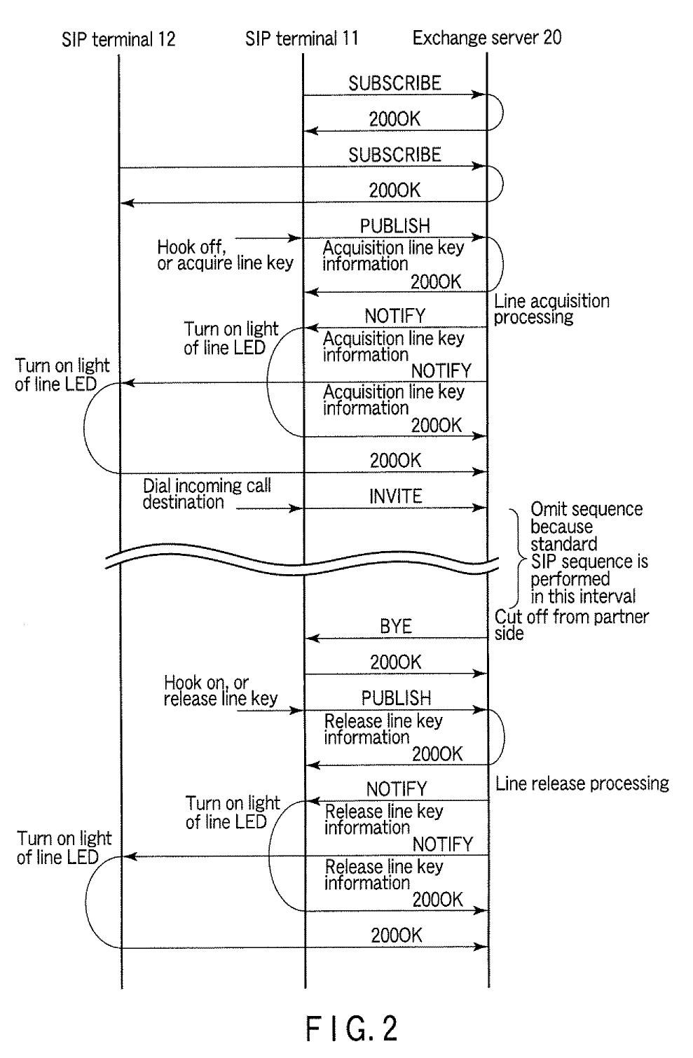

According to an embodiment, FIG. 2 shows a sequence view illustrating a first embodiment of messages to be transmitted and received among the SIP terminals and the exchange server 20. It is assumed that, in the following sequence, the SIP terminals 11, 12 assemble a multi-appearance. In FIG. 2, upon starting the system, namely when all the SIP terminals 11, 12 and the exchange server 20 are connected to the network (LAN), the SIP terminals 11, 12 transmit the “SUBSCRIBE” messages to the exchange server 20. If it is able to communicate with each SIP terminal, the exchange server 20 which has received the messages returns the “200 OK” messages to declare the acceptance of the requests. If the communication is failed for some reason, the “SUBSCRIBE” messages are refused by the exchange server 20.

When the user of the SIP terminal 11 presses the line button or operates off-hook, the SIP terminal 11 transmits acquisition line key information including data such as the number of pressed button and a off-hook signal to the exchange server 20 by describing the key information in the “PUBLISH” message. Then, the exchange server 20 reads the acquisition line key after returning the “200 OK” message and immediately acquires a line corresponding to the key information.

Further, the exchange server 20 immediately transmits the “NOTIFY” message with the acquisition line key information described therein to the SIP terminals 11, 12. Thereby, both the SIP terminals assembling the multi-appearance relating to the acquired lines may recognize the acquisition of the lines. These SIP terminals 11, 12 turn on lights of line buttons (LEDs) corresponding to the acquired lines and display that the lines are already in use.

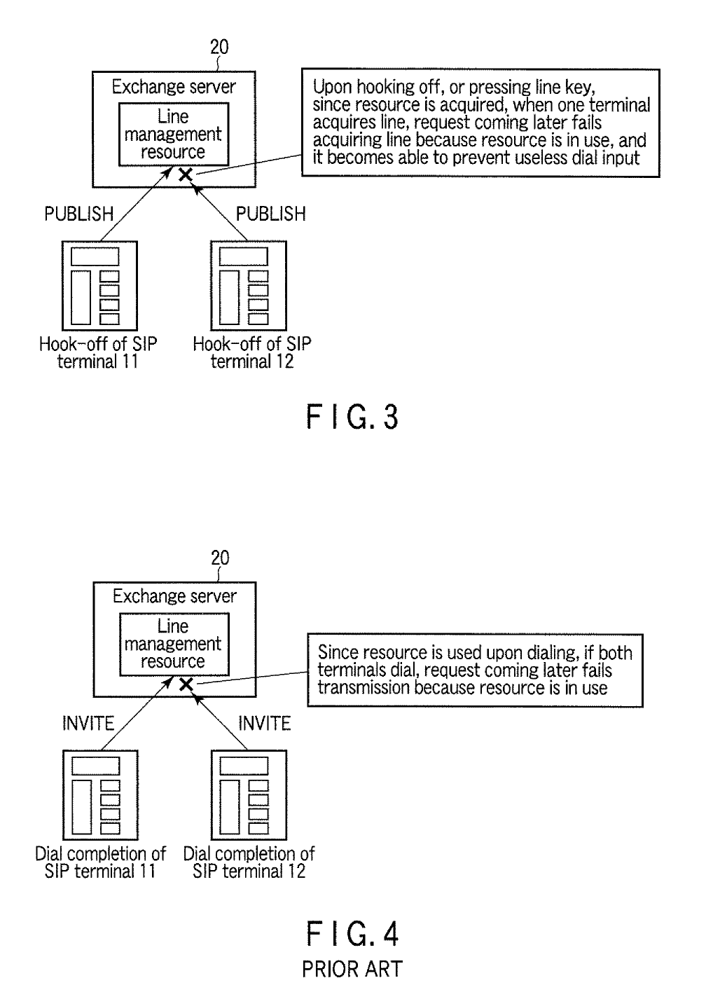

According to the above procedures, the “PUBLISH” and “NOTIFY” messages immediately notify the line acquisition information to a plurality of terminals. That is, as is shown in FIG. 3, upon hooking off or pressing the line key, the fact is notified to the exchange server 20 through the “PUBLISH” message, and since a line resource is immediately acquired by means of a line management resource, even if a line acquisition request is made after this, the acquisition results in failure because the resource has been in use. Therefore, in a situation in which a plurality of SIP terminals assembling the multi-appearance acquire the same line at the same time, users of terminals of the second or later may recognize that the line is in use upon pressing the line keys, and it makes possible to prevent useless dial input operations.

Now returning to FIG. 2; when the SIP terminal 11 inputs an incoming call destination dial number, after transmission of an “INVITE” message to the exchange server 20, a session is established between the SIP terminal 11 and a partner through a standard SIP sequence.

When the communication is terminated and the session is cut off by the partner, the exchange server 20 transmits a “BYE” message to the SIP terminal 11. Then, the user of the SIP terminal 11 is brought into a status of listening to a cut-off tone; however at this time point, the line is not released yet. After this, when the SIP terminal 11 performs an on-hook operation or a cut-off key pressing (releasing line key) operation, the key information of the pressed button and the off-hook signal are transmitted to the exchange server 20 through the “PUBLISH” message. At this time point, the exchange server 20 releases the acquired lines, and notifies release line key information to the SIP terminals 11, 12 through the “NOTIFY” messages. When receiving the key information, the SIP terminals 11, 12 return the “200 OK” messages then turn off the lights of the line LEDs and return to the empty (IDLE) status. According to the above procedures, it becomes able to prevent reception of incoming call messages from other terminals during listening to the cut-off tone.

In the existing SIP telephone system, as shown in FIG. 4, since acquisition timing of a resource is after the completion of the dial input, if both the two SIP terminals input dialing, a line acquisition request which has reached later results in a transmission failure because the line is in use. Conversely, in the first embodiment, although the system is one compliant with SIP, the line resource is immediately acquired after off-hook, and the fact is immediately informed to other SIP terminals. Therefore, it makes it possible to prevent the system from receiving the incoming call messages from other SIP terminals during dial input.

As described above, in the embodiment, the SIP terminal 11 transmits the “SUBSCRIBE” message to the exchange server 20, for example, when the SIP terminals starts. The “SUBSCRIBE” message does not aim to monitor any subject, and is not described an event package, etc., therein. When receiving such a “SUBSCRIBE” message, the exchange server 20 transfers the data toward the SIP terminal 11 through the “NOTIFY” message after this. The data may be one,, such as acquisition line key information, having no direct relationships to presence management. The SIP terminal 11 transfers the data to the exchange server 20 by using the “PUBLISH” message.

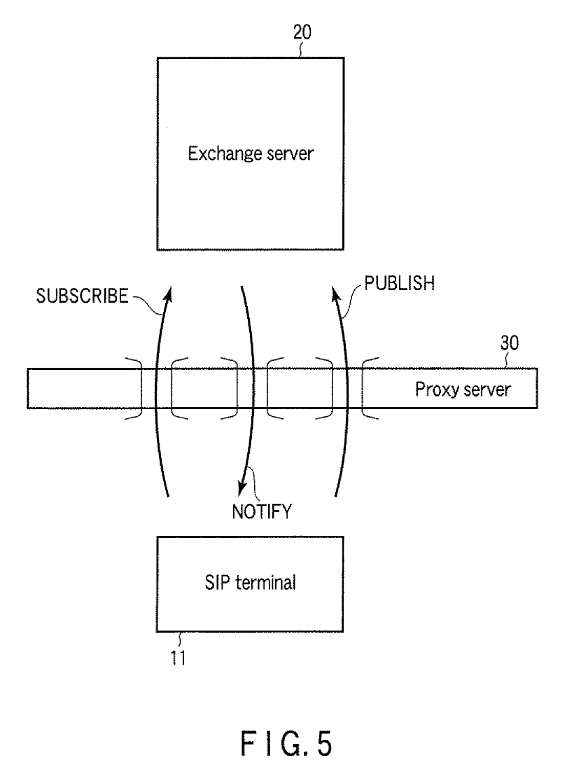

In this way, using the “NOTIFY” message from a reception side of the “SUBSCRIBE” message to a transmission side of the “SUBSCRIBE” message enables immediate notification of the generated data to the partner side. In a reverse direction link, transmitting the “PUBLISH” message regardless of a change in status also enables immediate notification of the data. Using the “PUBLISH” and “NOTIFY” messages without any relationship to event notification enables establishment of individual data communication paths between the exchange server 20 and the SIP terminal 11 supporting the SIP messages, as shown in FIG. 5. Since any the “SUBSCRIBE”, “NOTIFY”, and “PUBLISH” messages are defined in the framework of SIP, the proxy server 30 usually does not filter them. Thus, it is not necessary to apply various items of setting to the application layer gateway function of the proxy server 30, as long as the system is in an environment in which SIP may be used, the system can achieve interactive data communication without changing network setting. For the data communication, it is not necessary to define any unique message.

In this way, applying the message, such as “SUBSCRIBE”, “NOTIFY” and “PUBLISH” messages, to be used for the presence management to the data communication without being held to the frameworks makes it possible to establish the dedicated data communication paths among terminals and server. Therefore, the system may immediately notify the information of the on-hook, the off-hook, etc., to the server unit, immediately display the changes in status of the line keys, and enhance an immediate response property of the SIP telephone system. Further, it is not necessary to transmit the “SUBSCRIBE” message for each line button of the SIP terminals in a case of setting of the multi-appearance. Accordingly, it makes it possible to reduce the network traffic.

### Second Embodiment

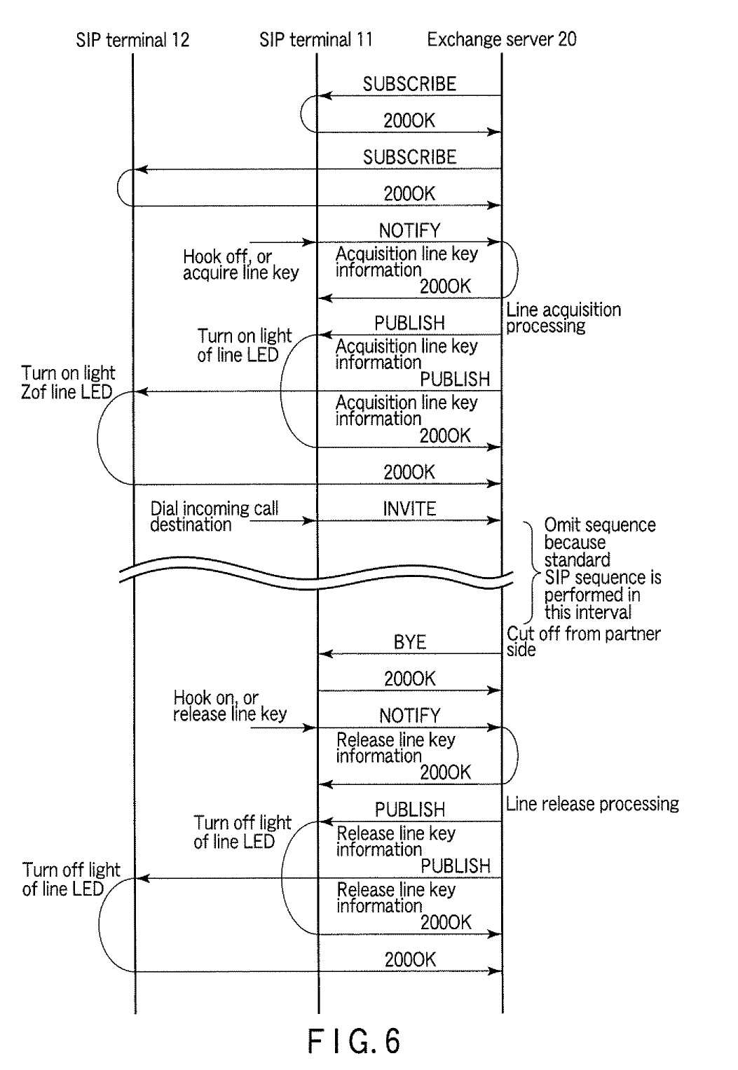

FIG. 6 shows a sequence view illustrating a second embodiment of the messages to be transmitted and received among the SIP terminals and the exchange server 20. While the first embodiment has been described the IP telephone system in which the SIP terminal 11 transmits the “SUBSCRIBE” message to the exchange server 20, the invention is not limited to the first embodiment, the exchange server 20 may also establish the data communication path by transmitting the “SUBSCRIBE” messages from the exchange server 20 to the SIP terminals. That is, as shown in FIG. 6, when the system is started, the exchange server 20 transmits the “SUBSCRIBE” messages to the SIP terminals 11, 12. The SIP terminals 11, 12 which have received these messages then notify acquisition line key information to the exchange server 20 after returning the “200 OK” messages. When receiving the key information, the exchange server 20 describes the key information in the “PUBLISH” message to transmit the key information to the SIP terminals 11, 12.

Similarly in the transmission and cut-off processing of after the “INVITE” message, mutual data communication from the SIP terminals 11, 12 and from the exchange server 20 is achieved through the “NOIFY” messages and the “PUBLISH” messages, respectively. Also in this way, the data communication paths may be established among SIP terminals and the exchange server 20.

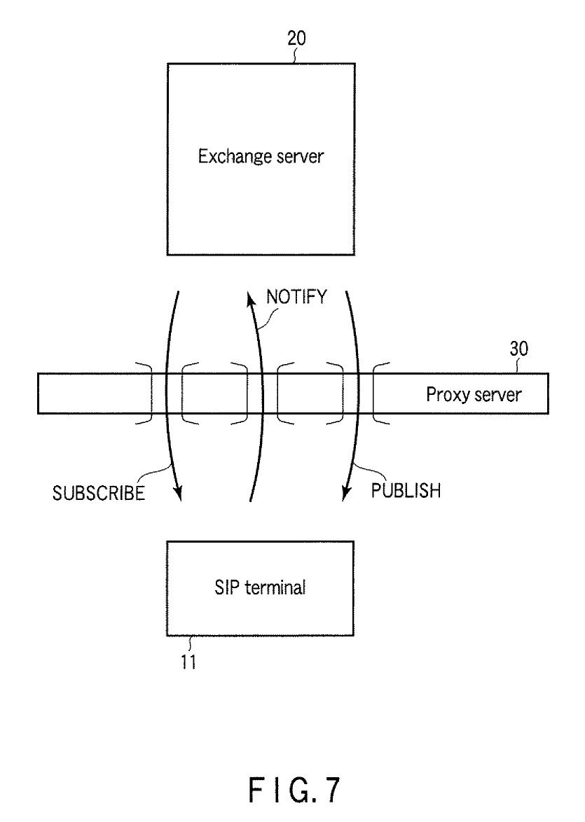

In the second embodiment, mainly the exchange server 20 establishes the data communication paths. That is, as shown in FIG. 7, the first “SUBSCRIBE” message is transmitted from an inside network to an outside network of the proxy server 30. According to the setting of the proxy server 30, although there is a case in which the communication paths may not be established only from the network located at the inner side of the proxy server 30, the IP telephone system of the second embodiment may establish the transmission paths even in such conditions.

### Third Embodiment

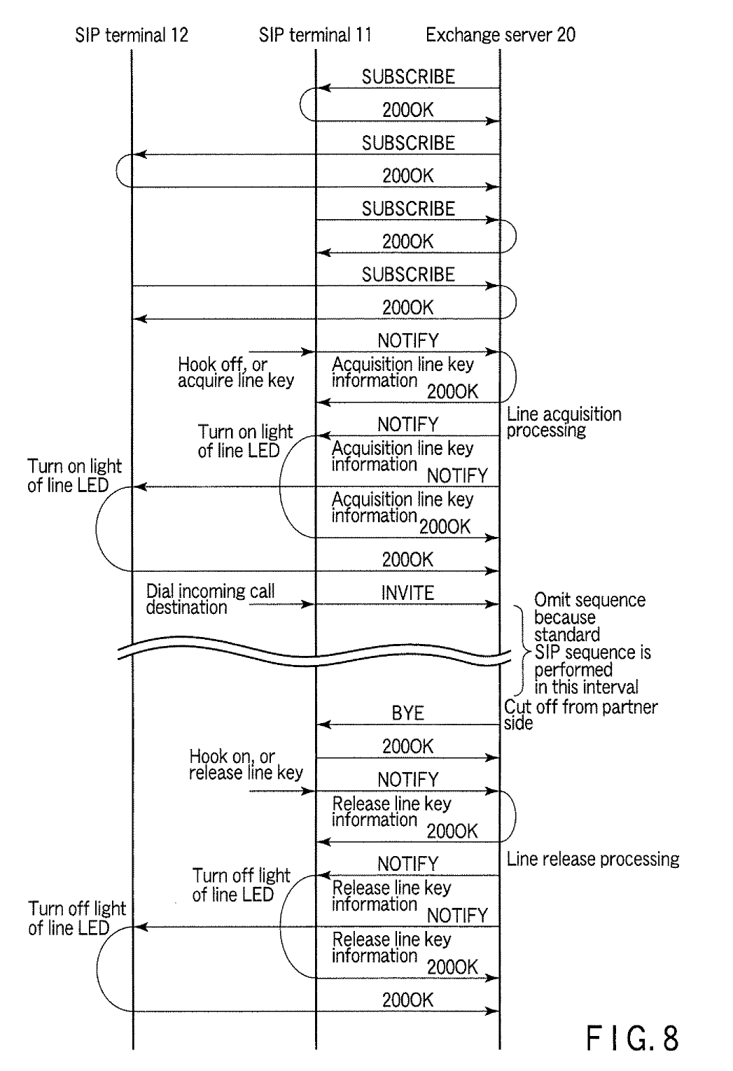

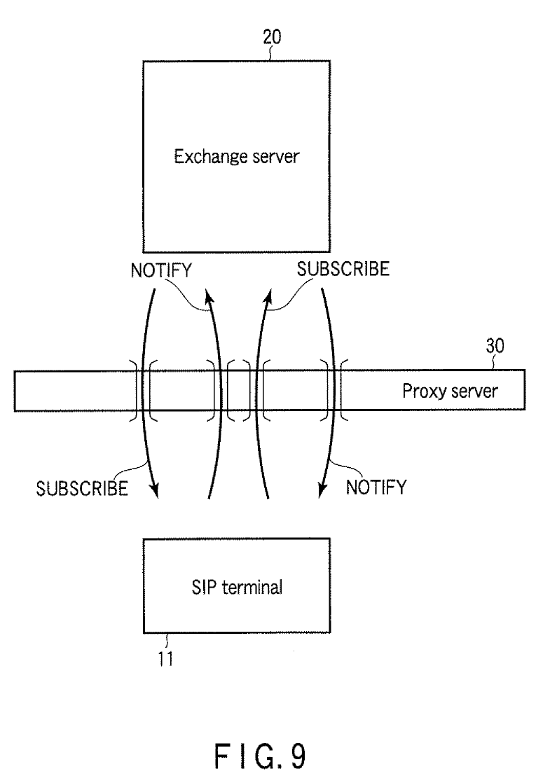

FIG. 8 is a sequence view illustrating a third embodiment of the messages to be transmitted and received among the SIP terminals and the exchange server 20. In the third embodiment, in any of the downlink and the uplink in the reverse direction to the SIP terminals 11, 12, the system declares the formation of the communication paths by firstly transmitting the “SUBSCRIBE” messages from the exchange server 20. Both of the SIP terminals 11, 12 which have received the “SUBSCRIBE” message and the exchange server 20 use the “NOTIFY” messages for the data communication to the partner. Also according to this way, the data communication paths may be formed beyond the proxy server 30, as shown in FIG. 9.

### Fourth Embodiment

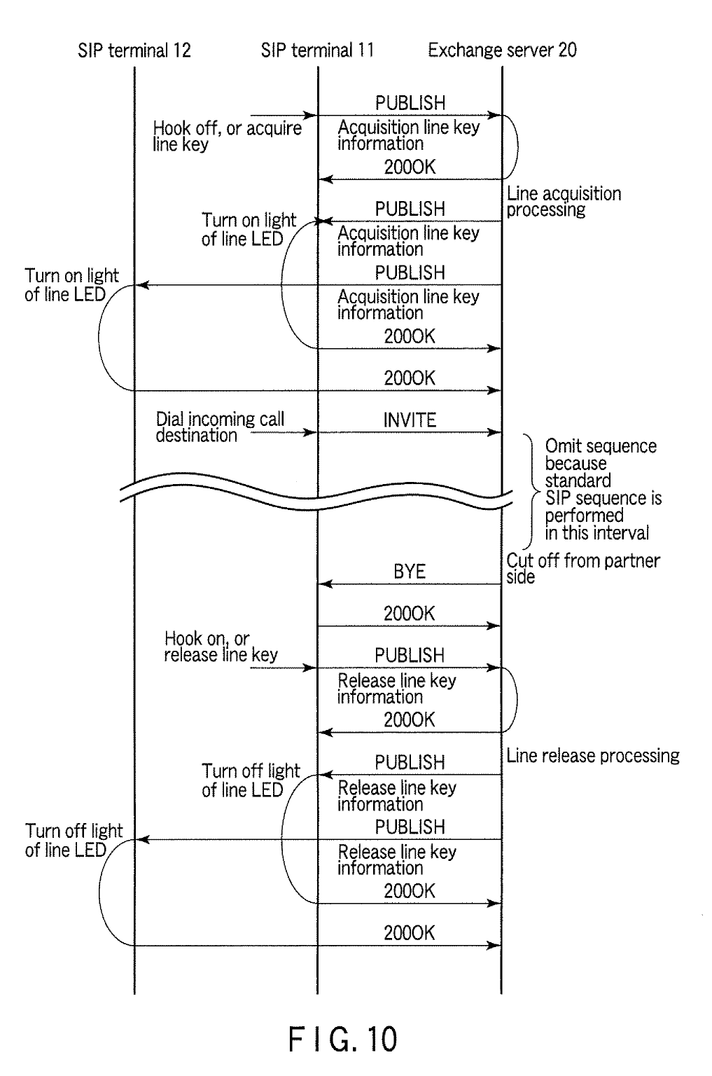

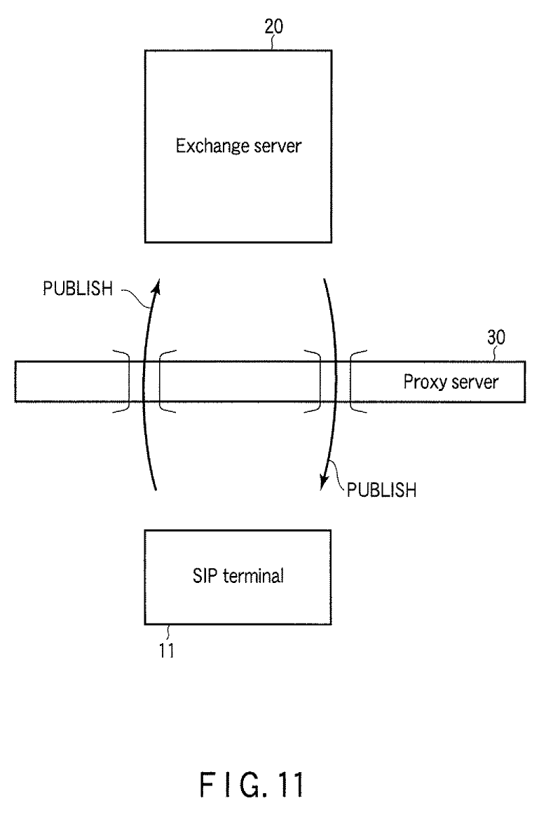

FIG. 10 is a sequence view illustrating a fourth embodiment of the messages to be transmitted and received among the SIP terminals and the exchange server 20. The sequence illustrates an example of a method for achieving interactive data communication by using only the “PUBLISH” messages. That is, if it is not necessary to form notification paths by means of the “SUBSCRIBE” message and “NOTIFY” message, it makes it possible to perform the interactive data communication by using only the “PUBLISH” messages, as shown in FIG. 11. As mentioned above, according to the first to fourth embodiments, the SIP telephone system, which enhances the immediate response property and reduces the network traffic, may be constructed.

The invention is not limited to the aforementioned embodiments. For instance, it is of course able to perform the data communication through the “PUBLISH” message in place of the “NOTIFY” message. Further, it is able to individually form a communication path by means of the “NOTIFY” message and a communication path by means of the “PUBLISH” message, and achieve a form in which communication through the “PUBLISH” message is given lower priority and communication through the “NOTIFY” message is given higher priority.

In the first to fourth embodiments, communication paths are formed when the system are started (when the exchange servers and the SIP terminals are started). Other than this, the communication paths may be formed for each communication, and may release the communication paths with terminations (BYE) of callings for each outgoing (INVITE) of calling.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A Session Initiation Protocol (SIP) telephone system comprising:
a server unit which is connected to Internet Protocol (IP) network;
telephone terminals which transmit and receive SIP messages to and from the server unit via the IP network; and
a module configured to apply SIP messages regarding event notification to data transmission to form interactive communication paths among the server unit and each of the telephone terminals.

2. The system of claim 1, wherein
each of the telephone terminals comprises:
an uplink transmission unit which transmits a “SUBSCRIBE” message to the server unit, and transmits data to the server unit by using a “PUBLISH” message after transmitting the “SUBSCRIBE” message; and
a downlink reception unit which receives the data transmitted from the server unit by using a “NOTIFY” message, and
the server unit comprises:
an uplink reception unit which receives the “SUBSCRIBE” messages transmitted from the telephone terminals; and
a downlink transmission unit which transmits the data by using “NOTIFY” messages to telephone terminals that are transmission sources after receiving the “SUBSCRIBE” messages.

3. The system of claim 1, wherein
the server unit comprises:
a downlink transmission unit which transmits “SUBSCRIBE” messages to the telephone units, and transmits data to the telephone terminals by using “PUBLISH” messages after transmitting the “SUBSCRIBE” messages; and
an uplink reception unit which receives data transmitted from the telephone terminals by using “NOTIFY” messages, and
each of the telephone terminals comprises:
a downlink reception unit which receives a “SUBSCRIBE” message transmitted from the server unit; and
an uplink transmission unit which transmits data by using a “NOTIFY” message to the server unit after receiving the “SUBSCRIBE” message.

4. The system of claim 1, wherein
the server unit comprises:
a downlink transmission unit which transmits “SUBSCRIBE” messages to the telephone terminals, and transmits data to the telephone terminals by using “NOTIFY” messages; and
an uplink transmission unit which transmits “SUBSCRIBE” messages to the server unit and transmits the data transmitted from the telephone terminals by using “NOTIFY” messages, and
each of the telephone terminal comprises:
an uplink transmission unit which transmits a “SUBSCRIBE” message to the server unit, and transmits data to the server unit by using a “NOTIFY” message after transmitting the “SUSCRIBE” message; and
a downlink reception unit which receives the data transmitted from the server unit by using the “NOTIFY” message from the server unit.

5. The system of claim 1, wherein
the server unit comprises:
a downlink transmission unit which transmits data to the telephone terminals by using “PUBLISH” messages; and
an uplink reception unit which receives data transmitted from the telephone terminals by using the “PUBLISH” messages; and
each of the telephone terminals comprises:
an uplink transmission unit which transmits data to the server unit by using a “PUBLISH” message; and
a downlink reception unit which receives the data transmitted from the server unit by using the “PUBLISH” message.

6. The system of claim 2, wherein
the server unit is disposed on a network positioned at an inner side of an application layer gateway which is readable to SIP.

7. The system of claim 3, wherein
the server unit is disposed on a network positioned at an inner side of an application layer gateway which is readable to SIP.

8. The system of claim 4, wherein
the server unit is disposed on a network positioned at an inner side of an application layer gateway which is readable to SIP.

9. The system of claim 5, wherein
the server unit is disposed on a network positioned at an inner side of an application layer gateway which is readable to SIP.

10. A data transmission method for use in a Session Initiation Protocol (SIP) telephone system which is provided with a server unit and telephone terminals to mutually transmit and receive SIP messages via Internet Protocol (IP), comprising:
applying SIP messages regarding event notification to data transmission; and
forming interactive communication paths among the server unit and each of the telephone terminals by using the SIP messages which are applied to data transmission.

11. The method of claim 10, further comprising:
transmitting, by the telephone terminals, a “SUBSCRIBE” message to the server unit;
transmitting, by the telephone terminals, data to telephone terminals by using a “PUBLISH” message after transmitting the “SUBSCRIBE” message; and
transmitting, by the server unit, the data to the telephone terminals that are transmission sources by using “NOTIFY” messages after receiving the “SUBSCRIBE” messages transmitted from the telephone terminals.

12. The method of claim 10, further comprising:
transmitting, by the server unit, “SUBSCRIBE” messages to the telephone terminals;
transmitting, by the server unit, data to the telephone terminals by using “PUBLISH” messages after transmitting the “SUBSCRIBE” message; and
transmitting, by the telephone terminals, data to the server unit by using a “NOTIFY” message after receiving a “SUBSCRIBE” message transmitted from the server unit.

13. The method of claim 10, further comprising:
transmitting, by the server unit, “SUBSCRIBE” messages to the telephone terminals;
transmitting, by the server unit, data to the telephone terminals by using “NOTIFY” messages after transmitting the “SUBSCRIBE” messages;
transmitting, by the telephone terminals, a “SUBSCRIBE” message to the server unit; and
transmitting, by the telephone terminals, data to the server unit by using a “NOTIFY” message after transmitting a “SUBSCRIBE” message.

14. The method of claim 10, further comprising:
mutually performing, by the server unit and the telephone terminals, interactive data transmission by using “PUBLISH” messages.

15. A server device which is disposed in a Session Initiation Protocol (SIP) telephone system including a server unit and a plurality of telephone terminals to mutually transmit and receive SIP messages via Internet Protocol (IP), comprising:
a first module configured to apply SIP messages regarding event notification to data transmission; and
a second module configured to form interactive communication paths among the server unit and each of the telephone terminals by using SIP messages applied to data transmission.

16. A telephone terminal for a Session Initiation Protocol (SIP) telephone system which is provided with a server unit and a plurality of telephone terminals to mutually transmit and receive SIP messages via Internet Protocol (IP), comprising:
a first module configured to apply SIP messages regarding event notification to data transmission; and
a second module configured to form interactive communication paths among the server unit and the telephone terminal by using SIP messages applied to data transmission.
